(19) United States
(12) Patent Application Publication
(10) Pub. No.: US 2002/0052817 A1
(43) Pub. Date: May 2, 2002

(54) Sales transactions for transfer of commodities

(76) Inventors: David Dines, Wayzata, MN (US); Mark Tracy, Minneapolis, MN (US); Joseph Stone, Petit Lancy (CH); Dennis Inman, Eden Prairie, MN (US); Jeffrey Seeley, Chanhassen, MN (US)

Correspondence Address: SHUMAKER & SIEFFERT, P.A., 150 Gateway Corporate Center 1, 576 Bielenberg Drive, St.Paul, MN, 55125, US

(21) Appl. No.: 09/862,995

(22) Filed: May 22, 2001

Related U.S. Application Data
(60) Provisional application No. 60/245,373, filed on Nov. 2, 2000.

(51) Int. Cl. G06F 17/60

(52) U.S. Cl. 705/36; 705/39

(57) ABSTRACT

A method for transacting transfers of commodities includes setting a first price for a first quantity of a commodity based on an average price observed during a period of time and either a premium or discount to the average price. A second price is set for a second quantity of a commodity based on a price determined at a future date. The second price does not exceed a maximum price in the event a premium applies to the first quantity, or a minimum price in the event a discount applies to the first quantity. The first quantity and the second quantity are delivered from a seller to a buyer, and the seller is paid a sum based on the first price, the premium or discount, as applicable, and the second price.

This application claims priority from U.S. provisional Application No. 60/245,373, filed Nov. 2, 2000, the entire content of which is incorporated herein by reference.

### TECHNICAL FIELD

The invention relates to the commodities business and, more particularly, to transactions involving the transfer of market commodities.

### BACKGROUND

To offset some of the risks associated with market volatility in commodities market, sellers sometimes enter into agreements with buyers of the commodities. The agreements often set prices based on futures prices, and may include quantity requirements, price floors, and price ceilings. With such an agreement, the seller may achieve some level of comfort in his ability to market commodities at a reasonable price. The agreement thereby reduces the seller's vulnerability to price risks that can cut into profits and drive him out of business. In return, the buyer achieves access to a predetermined quantity of the commodity, and is able to hedge the implicit risks associated with the price obligations in the agreement.

### SUMMARY

The invention is directed to a method for transacting exchanges of commodities. The exchange may be transacted between a buyer and a seller who is a producer of the commodity, or between a buyer and a seller who is not producer. A seller, other than a producer, may be an entity that buys commodities from a producer (or another reseller) and then resells the commodities to another buyer. Thus, a buyer may contract directly with a producer or with an intermediary in the form of a buyer/reseller of commodities.

The invention presents techniques by which a buyer and a seller may allocate their respective risks. The buyer guarantees an average price for a first quantity of a first premium over the average, or the seller guarantees a discount under the average, depending upon variable pricing requirements applicable to a second quantity of a second commodity. The first and second commodities may be different commodities, such as silver and gold, or they may be the same commodity.

In one embodiment, the invention provides a method for transacting exchanges of commodities, the method comprising setting a first price for a first quantity of a first commodity based on an average price observed during a period of time and a premium above the average price, setting a second price for a second quantity of a second commodity based on a price determined at a future date, wherein the second price is capped so as to not exceed a maximum price, delivering both the first quantity and the second quantity from a seller to a buyer, and paying the seller a sum based on the first price, the premium, and the second price.

In another embodiment, the invention provides a method for transacting exchanges of commodities, the method comprising setting a first price for a first quantity of a first commodity based on an average price observed during a period of time and a discount to the average price, setting a second price for a second quantity of a second commodity based on a price determined at a future date, wherein the second price is floored so as not to drop below a minimum price, delivering both the first quantity and the second quantity from a seller to a buyer, and paying the seller a sum based on the first price, the discount, and the second price.

The methods can provide a seller, such as a commodity producer or or reseller of commodities, with greater price certainty in exchange for delivery of both the first and second quantities of the commodity. In addition, the methods can provide the seller with a premium or a guaranteed minimum price. In return, the buyer benefits from greater certainty with respect to quantity, and can hedge the implicit risks associated with the price obligations. In one embodiment, the price calculation for the first quantity is based on an average price and includes a premium, while the price calculation for the second quantity may be based on a futures price and is subject to a maximum level. In an alternative embodiment, instead of a premium, the first price may be subject to a discount, in which case the price for the second amount is subject to a minimum price level.

In another embodiment, the seller must deliver the second quantity to the buyer in order to receive the premium for the first quantity. In other embodiments, delivery of the second quantity may be optional. In either case, delivery need not be physical, and may refer to any other form of legal transfer of ownership directly or indirectly from producer or reseller to buyer. However, the agreement still is tied to a physical quantity of the commodity, i.e., at least the first quantity. The method makes use of first and second quantities with different price calculations that better balance the risk between the seller and buyer. In addition, the method ensures that more actual underlying commodity is exchanged between the seller and the buyer. In this manner, the buyer and seller both benefit from the arrangement.

The details of one or more embodiments of the invention are set forth in the the description below. Other features, objects, and advantages of the invention will be apparent from the description, and from the claims.

### DESCRIPTION OF THE DRAWINGS

FIG. 1 is a diagram illustrating the interaction between a seller of a commodity and a buyer according to an embodiment of the invention.

FIG. 2 is a diagram illustrating the interaction between a seller of a commodity and a buyer according to another embodiment of the invention.

### DETAILED DESCRIPTION

In accordance with the invention, a method for transacting exchanges of commodities includes setting a first price for a first quantity of a first commodity. The first price is based on an average price observed during a period of time and either a premium or discount to the average price. Thus, the first price and premium or discount are combined and applied to the first quantity to produce a first amount that is payable to the seller by a buyer, e.g., upon delivery of the first quantity.

The amount payable is not necessarily the cash price, i.e., the sum actually paid to the seller. The cash price reflects the agreed-upon price for the commodity, but the cash price may also be adjusted for factors such as quality.

A second price is set for a second quantity of a second commodity. The second commodity may be the same as the first commodity, for example, both the first and second commodities may be silver. Alternatively, the first and second commodities may be different commodities, such as silver and gold. Unlike the first price, however, the second price is based on a price determined at a future date. The second price may be, for example, a futures price.

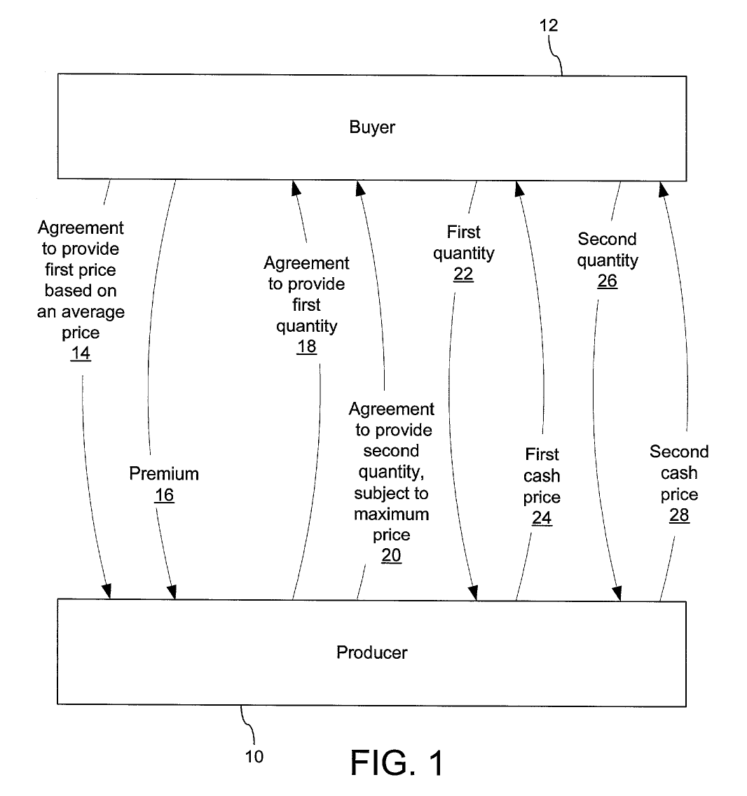

FIG. 1 illustrates a typical arrangement in accordance with the invention. Buyer 12 agrees to buy a first quantity of a commodity from a seller, producer 10, at a first price based on an average price observed during a period of time (14). Buyer 12 further agrees to pay to producer 10 a premium above the average price (16). In return, producer 10 agrees to provide the first quantity at the first price (18). Producer 10 further agrees to provide the second quantity at the second price, based on a futures price. In addition, the second price is capped so as not to exceed a maximum price (20). Thus, in the event the futures price exceeds the maximum price, the second price is capped at the maximum price. The second price is applied to the second quantity to determine a second amount payable to producer 10 by buyer 12.

As a condition to receipt of the first amount, and thus the premium, producer 10 must deliver both the first quantity (22) and the second quantity (26), assuring buyer 12 a predefined quantity level. In exchange, buyer 12 must pay producer 10 cash prices based on the first and second amounts, which are based on application of the sum of the first price and the premium or discount to the first quantity (24) and application of the second price to the second quantity (28).

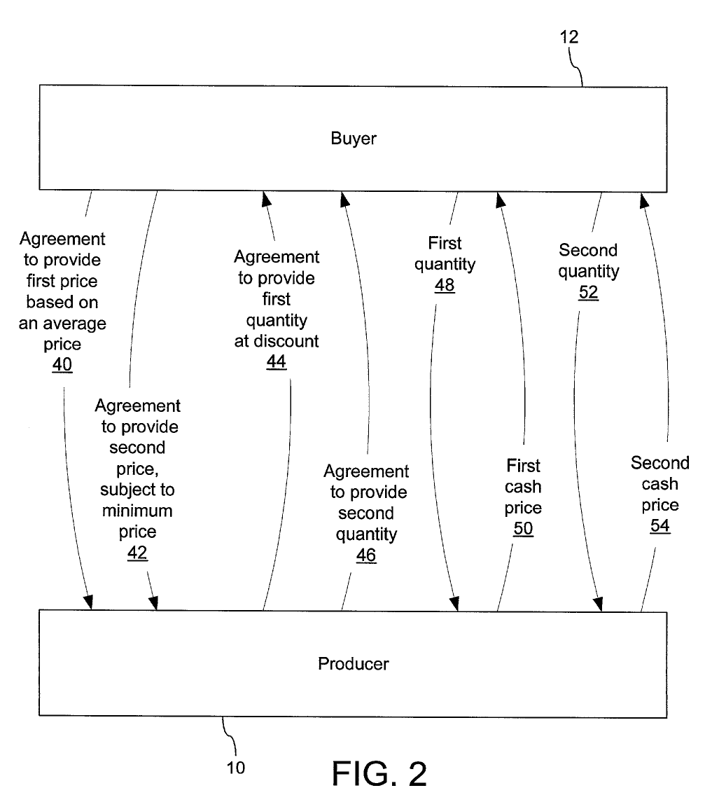

FIG. 2 illustrates an alternate arrangement in accordance with the invention, in which the second price is floored so as not to go below a minimum price. Buyer 12 agrees to buy a first quantity of a commodity from producer 10 at a first price based on an average price observed during a period of time (40). Producer 10 agrees to provide the first quantity at the first price, which includes a discount (44). Buyer 12 further agrees to pay to producer 10 a second price for a second quantity, subject to a minimum price (42), and producer 10 agrees to provide the second quantity (46).

Producer 10 must deliver both the first quantity and the second quantity (48, 52), assuring buyer 12 a predefined quantity level. In exchange, buyer 12 must pay producer 10 cash prices based on the first and second amounts (50, 54). Producer 10 accepts an average price on the first quantity, less a discount. In return, buyer 12 guarantees producer 10 a minimum price for the second quantity, which may exceed the market price.

The term “producer” may refer to any producer or manufacturer of a commodity, from an individual manufacturer to a large corporate operation. A “commodity” produced by the producer may take the form of any commodity commonly traded or likely to be traded in the future on an open or closed market basis. Examples of commodities that are presently traded on the open market include crude oil, heating oil, unleaded gasoline, jet fuel, kerosene, propane, water, communication or computing bandwidth, semiconductor chips, pollution/emission rights, gold, silver, palladium, aluminum, copper, steel, lead, other metals, and the like.

A “buyer” may take the form of an end purchaser of the commodity for processing, integration, or resale, or any other outlet for the commodity, and may form part of an integrated commodities trader, or an entity or collection of entities that purchase commodities and trades them on an open market. A “seller” may be an producer or any other entity that buys commodities from a producer or elsewhere and resells them to a buyer. Thus, the seller may be a reseller or “middleman” who trades in commodities but does not produce, process, or integrate them. A buyer, at a given level in the transaction chain, also may be a reseller.

An agreement in support of the transaction may be between producer and a buyer, or between a buyer/reseller and a buyer. Thus, a buyer/reseller may have contractual obligations to both the buyer and the producer, and can be viewed as an intermediary.

For an energy commodity such as crude oil, an example transaction chain could include an oil producing company who sells to a middleman that operates a tanker fleet. The middleman may ship to a middleman refiner, who sells to a middleman trucking company. Finally, the trucking company may sell to a gas station owner, who dispenses gasoline to the end consumer.

With water as the commodity, an example transaction chain could include a state that owns a reservoir, and sells to a water utility company. The water utility company may then sell to an irrigating farmer.

For metals, an example transaction chain could include a mining company, who sells to a shipping company. The shipping company may sell to a processor, who then sells to an end processor or integrator, e.g., an automotive parts company or automobile manufacturer.

A method in accordance with the present invention provides an alternative to sellers and buyers. It provides an additional premium over or discount below an average price observed during a given time frame for an initial quantity exchanged. In addition, it provides an opportunity to earn some limited benefit from price changes affecting a second quantity committed at the same time.

To make the premium or discount feasible, the buyer and seller agree to exchange an initial “first” quantity and pay the average (plus or minus the premium or discount) of an observed price over a known period. Also, the buyer and seller agree to transact an exchange of the second quantity at a price to be determined. The price for the second quantity may be determined by reference to any mutually agreed upon index for the particular commodity, such as a futures price.

In consideration of a premium paid to the seller, the price for the second quantity may be made subject to a maximum price level. In this case, the seller benefits from the premium on the first quantity while the buyer benefits from a price ceiling on the second quantity.

In consideration of the discount, the price of the second quantity may be subject to a minimum price level. In this case, the seller benefits from a price floor on the second quantity while the buyer benefits from the discount on the first quantity.

In this manner, a buyer's customer, e.g., a commodities producer, can get paid the average plus a known premium. Conversely, a seller's customer, e.g., a commodities trader, can acquire at the average less the known discount. In either case, the price level for the second quantity is determined by another price structure and is subject to the minimum price level in the case of a discount or the maximum price level in the case of a premium.

Notably, there is no limit on how high or low the average price may go for purposes of calculating the first price for the first quantity. In addition, two distinct methods are used to price the first and second quantities. There is no option on the part of the buyer or seller to take or make delivery of the first quantity. In addition, for regulatory compliance, there ordinarily will be no option to take or make delivery of the second quantity. Rather, delivery of both quantities at the agreed upon prices ordinarily will be mandatory under the agreement. If regulatory requirements change, however, it is conceivable that delivery of the second quantity may be optional and determined by the level of the second price at the time of delivery or some other time agreed upon by the parties.

The premium or discount may be above, equal to, or below the predefined average depending on the specifics of a particular commodity or combination of commodities. The premium or discount may be paid and received at any time agreed upon by the buyer and seller. Timing of the payment could result, for example, in implicit financing revenue or cost to either or both parties.

As further distinctions, the method need not result in indemnified profit sharing between the buyer and seller. Instead, it guarantees a premium over the average or a discount under the average for the first quantity, in consideration of variable pricing requirements applicable to the second quantity. The pricing structure for the second quantity presents a risk to both the buyer and seller.

According to the invention, a contract between the parties may include:

(a) A first agreement for a buyer and seller to receive and pay, respectively, the average price observed during a given time frame plus a premium or minus a discount for an initial quantity. The calculation method for the average price is predefined and no boundaries on the averaging points need exist.

(b) A mandatory second agreement, made simultaneously and inseparable from the first agreement, providing that in exchange for the premium or discount, as the case may be, the buyer and seller will receive and deliver, respectively, a second quantity based on a price to be known at a future date. The price at the future date may be limited to a maximum in the case a premium is applied to the first quantity, or a minimum in the case a discount is applied to the first quantity.

To establish the average price, the parties may agree to a readily observable price with known observation times, dates, and other conditions. For example, the parties may agree to observe the price every day, every other day, every week, every month, on selected dates, and so forth. Any observable price may be used. Exchange-based futures prices are a common source of averaging points, and are suitable for this calculation. The parties may agree, for example, that the observed price on a particular day shall be the closing price on the exchange that day. Other indices of average price may be used.

The parties may agree to calculate the average price in many ways. Typically, the parties would use the arithmetic mean, but they may agree to other methods of calculation, such as a weighted average or a median or a mode.

To create the maximum or minimum price, the parties may additionally commit to a pricing structure that may resemble an option. The date and time of the beginning and ending of the averaging period for the first quantity and the pricing structure for the second quantity are determined at the time of contracting.

As an example, assume that the date is Jun. 2, 2002 and that February 2003 futures for gold at a particular exchange are trading at 338.00 (dollars per ounce). Also assume that a producer wants to sell a commodity for future delivery in November 2002. For a first quantity of the commodity, e.g., a first half, the producer would like to earn a premium in excess of the average price observed from June through Nov. 15, 2002. The producer also would like to have a confirmed agreement to sell a second quantity of the commodity, e.g., a second half, at the prevailing price on Nov. 15, 2002.

The producer believes that prices are unlikely to be above 364.00 on Nov. 15, 2002, but considers that to be a desirable price for the second half. Therefore, he is willing to forego potential gains above 364.00 on the second half, in exchange for a guaranteed premium of ten dollars per unit above the average for the first half. Thus, for this example, the producer agrees to exchange the first half at the average plus the premium, and the second half at the ending price subject to the maximum of 364.00.

In a first case, prices fall from 338.00 on Jun. 2, 2002 to 249.00 on Nov. 14, 2002, and the average over that period is 277.00. Application of the average of 277.00 to the first half is better than taking the ending value. Additionally, earning the extra ten dollar premium above the average for the first half for a total of 287.00 is even better. The second half earns the lower ending price of 249.00, but is buoyed by the price for the first half.

In a second case, prices rise from 338.00 to 339.00 between Jun. 2, 2002 and Nov. 14, 2002, and the average over that period is 335.00. In this case, earning the extra ten dollars above the average for a total of 345.00 for the first half of the owner's supply of the commodity is better than both the beginning and ending prices, as well as the average. The second half of the owner's supply is delivered at the ending price of 339.00, making for a rather successful marketing result for the producer's total commodity.

In a third case, prices rise from 338.00 to 366.00 between Jun. 2, 2002 and Nov. 14, 2002, and the average over that period is 362.00. The producer is paid the average of 362.00 plus the ten dollar premium for a total of 372.00 for the first half of the owner's supply. The second half of the owner's supply earns 364.00 because the ending price of 366.00 barely exceeded the agreed upon maximum of 364.00. In this case, the buyer benefits slightly from the maximum price applied to the second half of the owner's supply.

In a fourth case, prices rise from 338.00 to 412.00 between Jun. 2, 2002 and Nov. 14, 2002, and the average over that period is 378.00. With the ten dollar premium, the price for the first half of the commodity is 388.00. The second half of the commodity is the maximum of 364.00 as the ending price greatly exceeded the maximum. For this case, the buyer benefits significantly from the maximum price applied to the second half of the commodity.

Scenarios similar to those above can be envisioned for an arrangement in which a seller and buyer agree that the first quantity will be subject to an average price minus a discount, and the second quantity will be an ending price subject to a minimum price. In some instances, the minimum will benefit the seller by insulating the second quantity against excessive downward price trends. In other instances, the discount provided to the buyer will compensate for excessive price increases.

The method is applicable to a variety of implementations. The method may be carried out manually, for example, between the buyer and seller of the commodities. It may be practiced at multiple levels in the supply channel, i.e., between the producer and intermediate buyer, and then between the intermediate buyer (as seller) and a subsequent buyer. One or more intermediate buyers are envisioned. The method may benefit from automation and aggregation at the intermediate level, permitting a trader situated upstream from an intermediate trader to take on an aggregation of contracts in accordance with the method rather than individual contracts with producers. Moreover, the confidentiality of the ultimate buyer or seller and the producer may be preserved. In particular, the intermediate buyer/reseller need not disclose their identities, providing the advantage of anonymity. A suitable delivery system for implementation of aggregation and anonymity is described in U.S. provisional application Ser. No. 60/245,412, to David E. Dines et al., entitled “Sales Transactions for Transfer of Commodities,” filed Nov. 2, 2000.

A number of embodiments of the present invention have been described. Nevertheless, it will be understood that various modifications may be made without departing from the spirit and scope of the invention. Accordingly, other embodiments are within the scope of the following claims.

1. A method for transacting exchanges of commodities, the method comprising:
setting a first price for a first quantity of a first commodity based on an average price observed during a period of time and a premium above the average price;
setting a second price for a second quantity of a second commodity based on a price determined at a future date, wherein the second price is capped so as to not exceed a maximum price;
delivering both the first quantity and the second quantity from a seller to a buyer; and
paying the seller a sum based on the first price, the premium, and the second price.

2. The method of claim 1, wherein the first price is a per unit price X1, the premium is a per unit price Y1, the second price is a per unit price X2, the first quantity is Q1 units, the second quantity is Q2 units, and the sum paid to the seller is based on (X1+Y1)*Q1+X2*Q2.

3. The method of claim 1, wherein the seller is a producer of commodities.

4. The method of claim 1, wherein the buyer is a reseller of commodities.

5. The method of claim 1, wherein the commodities include at least one of crude oil, heating oil, unleaded gasoline, jet fuel, kerosene, propane, water, communication or computing bandwidth, semiconductor chips, pollution/emission rights, gold, silver, palladium, aluminum, copper, steel, and lead.

6. The method of claim 1, wherein the first commodity is the same as the second commodity.

7. A method for transacting exchanges of commodities, the method comprising:
setting a first price for a first quantity of a first commodity based on an average price observed during a period of time and a discount to the average price;
setting a second price for a second quantity of a second commodity based on a price determined at a future date, wherein the second price is floored so as not to drop below a minimum price;
delivering both the first quantity and the second quantity from a seller to a buyer; and
paying the seller a sum based on the first price, the discount, and the second price.

8. The method of claim 7, wherein the first price is a per unit price X1, the discount is a per unit price Y1, the second price is a per unit price X2, the first quantity is Q1 units, the second quantity is Q2 units, and the sum paid to the seller is based on (X1−Y1) *Q1+X2*Q2.

9. The method of claim 7, wherein the seller is an reseller of commodities.

10. The method of claim 7, wherein the buyer is a reseller of commodities.

11. The method of claim 7, wherein the commodities include at least one of of crude oil, heating oil, unleaded gasoline, jet fuel, kerosene, propane, water, communication or computing bandwidth, semiconductor chips, pollution/emission rights, gold, silver, palladium, aluminum, copper, steel, and lead.

12. The method of claim 7, wherein the first commodity is the same as the second commodity.

13. A method for transacting exchanges of commodities, the method comprising:
setting a first price for a first quantity of a first commodity based on an average price observed during a period of time and a premium above the average price;
setting a second price for a second quantity of a second commodity based on a price determined at a future date, wherein the second price is capped so as not to exceed a maximum price;
delivering at least the first quantity from a seller to a buyer; and
paying the seller a sum based at least in part on the first price and the premium.

14. The method of claim 13, further comprising delivering both the first quantity and the second quantity from the seller to the buyer, and paying the seller a sum based on the first quantity, the first price, the second quantity, the second price, and the premium.

15. The method of claim 13, wherein the seller is a producer of commodities.

16. The method of claim 13, wherein the buyer is a reseller of commodities.

17. The method of claim 13, wherein the commodities include at least one of crude oil, heating oil, unleaded gasoline, jet fuel, kerosene, propane, water, communication or computing bandwidth, semiconductor chips, pollution/emission rights, gold, silver, palladium, aluminum, copper, steel, and lead.

18. The method of claim 13, wherein the first commodity is the same as the second commodity.

19. A method for transacting exchanges of commodities, the method comprising:
setting a first price for a first quantity of a first commodity based on an average price observed during a period of time and a discount above the average price;
setting a second price for a second quantity of a second commodity based on a price determined at a future date, wherein the second price is floored so as not to drop below a minimum price;
delivering at least the first quantity from a seller to a buyer; and
paying the seller a sum based at least in part on the first price and the discount.

20. The method of claim 19, further comprising delivering both the first quantity and the second quantity from the seller to the buyer, and paying the seller a sum based on the first quantity, the first price, the second quantity, the second price, and the discount.

21. The method of claim 19, wherein the seller is a producer of commodities.

22. The method of claim 19, wherein the buyer is a reseller of commodities.

23. The method of claim 19, wherein the commodities include at least one of crude oil, heating oil, unleaded gasoline, jet fuel, kerosene, propane, water, communication or computing bandwidth, semiconductor chips, pollution/emission rights, gold, silver, palladium, aluminum, copper, steel, and lead.

24. The method of claim 19, wherein the first commodity is the same as the second commodity.
